(19) United States
(12) Patent Application Publication
(10) Pub. No.: US 2009/0072175 A1
(43) Pub. Date: Mar. 19, 2009

(54) PRESSURE REDUCING VALVE

(76) Inventor: Ming-Hsiung Hsu, Taichung County (TW)

Correspondence Address: PAI PATENT & TRADEMARK LAW FIRM, 1001 FOURTH AVENUE, SUITE 3200, SEATTLE, WA, 98154, US

(21) Appl. No.: 11/855,429

(22) Filed: Sep. 14, 2007

(51) Int. Cl. F16K 25/00

(52) U.S. Cl. 251/190

(57) ABSTRACT

A pressure reducing valve is disclosed to include a housing connected to a compression gas source and covered with an end cap, a piston mounted in the housing and defining with the end cap an air chamber, a cylindrical elastic plastic member stopped between the piston and an inside part of the housing, and a valve flap held down by a return spring to close the air chamber.

### BACKGROUND OF THE INVENTION

1. Field of the Invention

The present invention relates to a pressure reducing valve for reducing the pressure of compressed gas, and more particularly to such a pressure reducing valve that reduces the pressure of compressed gas through one step for output.

2. Description of the Related Art

To regulate the pressure of a compressed gas to a proper working pressure level for working, a pressure reducing valve is generally used. For example, a paintball gun used in a war game uses a gas pressure to shoot a paintball. Regular paintball guns include high-pressure paintball guns (with firing pressure at 800-950 PSI) and low-pressure paintball guns (with firing pressure at 450-550 PSI). When a same pressure of compressed gas is used, a low-pressure paintball gun can shoot more paintballs than a high-pressure paintball gun. A low-pressure paintball gun requires a secondary pressure reducing mechanism. Pressure reducing valves for this purpose are seen in U.S. Pat. No. 6,543,475 and Taiwan Utility Number M265591. According to these designs, Belleville disk spring is utilized to regulate an input working pressure to an output delivery pressure, and a piston is acting as a guide for the Belleville disk spring. The piston directs air from a pressure vessel. The Belleville disk spring is configured such that a determined amount of spring energy can be used to offset gas pressure energy. Further, a spiral spring may be used to substitute for the Belleville disk spring, achieving the same effect.

The aforesaid Belleville disk spring and spiral spring are made of alloy steel or high carbon steel that has a high rigidity, therefore they do not allow for reduction of gas pressure to 200 PSI or lower. The use of the Belleville disk spring or spiral spring in a pressure reducing valve still has numerous drawbacks as follows:
1. Both the Belleville disk spring and spiral spring have the problem of size or diameter tolerance.
2. Because the Belleville disk spring and spiral spring require a thermal treatment, the problems of hardness tolerance and evenness in hardness exist.
3. The moisture produced during filling of compressed gas into the high-pressure gas cylinder tends to cause the Belleville disk spring/spiral spring to rust.
4. Because the Belleville disk spring is comprised of multiple disk spring elements and has a directional limitation in installation, the installation of the Belleville disk spring requires much labor and time.
5. When the Belleville disk spring/spiral spring starts to rust, fallen steel dust may affect the tightness of the internal rubber gasket rings.
6. The fabrication of the Belleville disk spring/spiral spring is not in conformity with environmental protection. For example, the fabrication of the spiral spring comprises the steps of shape forming, end portion grinding, thermal treatment, and electroplating. The chemical agents used during electroplating are pollutants that cause environmental pollution seriously.

### SUMMARY OF THE INVENTION

The present invention has been accomplished under the circumstances in view. It is the main object of the present invention to provide a pressure reducing valve, which has a simple structure that is highly stable and easy to install, and which effectively reduces the pressure of a compressed gas to the desired low pressure level through one single step without a secondary pressure reducing action.

To achieve this and other objects of the present invention, the pressure reducing valve comprises a housing connected to a compression gas source and covered with an end cap, a piston mounted in the housing and defining with the end cap an air chamber, a cylindrical elastic plastic member molded from a polymeric material through injection molding, extrusion molding, or foam molding, and stopped between the piston and an inside part of the housing, and a valve flap held down by a return spring to close the air chamber.

### BRIEF DESCRIPTION OF THE DRAWINGS

FIG. 1 is an exploded view of a pressure reducing valve in accordance with the present invention.

### DETAILED DESCRIPTION OF THE PREFERRED EMBODIMENT

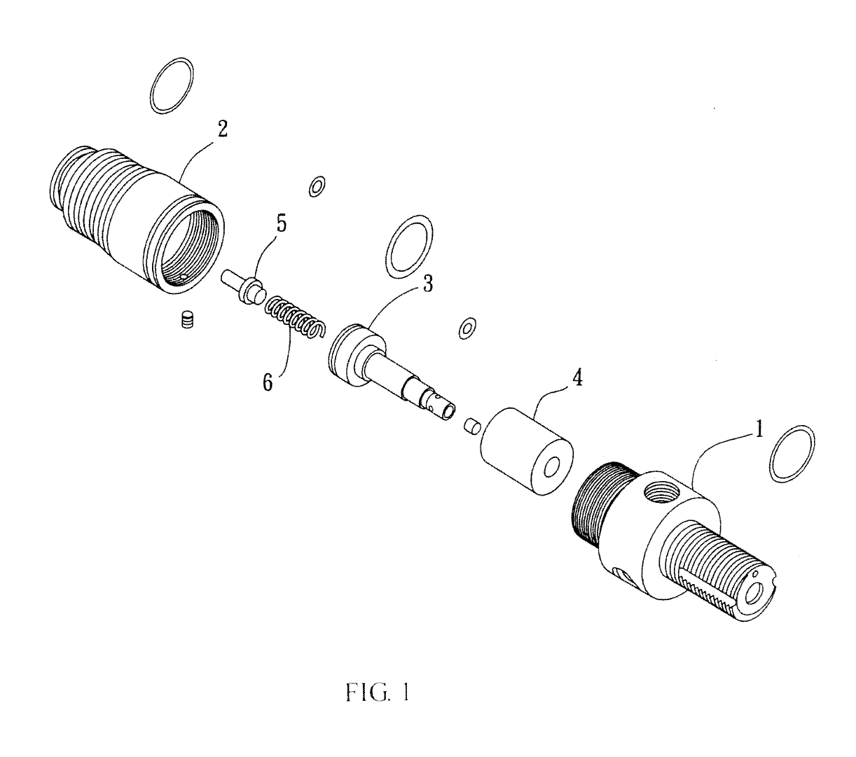

Referring to the annexed drawing of FIG. 1, a pressure reducing valve in accordance with the present invention is shown comprising a housing 1 connected to a high-pressure gas source (not shown), and an end cap 2 fastened to the housing 1.

The housing 1 and the end cap 2 are fastened together by means of, for example, a screw joint (not shown), defining therein an accommodation chamber that accommodates a piston 3, a cylindrical elastic plastic member 4, a valve flap 5, and a return spring 6. The piston 3 defines with the end cap 2 an air chamber (not shown) within the housing 1. The cylindrical elastic plastic member 4 is stopped between the piston 3 and a part inside the housing 1. After overcoming the pressure of the cylindrical elastic plastic member 4, the compressed gas pushes the piston 3 to reduce the pressure and is then stored in the air chamber for output. The return spring 6 is connected between the valve flap 5 and the piston 3 and adapted to return the piston 3. When the valve flap 5 is opened, pressure-reduced gas is allowed to pass out of the air chamber. The operating principle of the pressure reducing valve is substantially similar to U.S. Pat. No. 6,543,475, which is herein incorporated by reference. Therefore, no further detailed description in this regard is necessary.

The main feature of the present invention is the cylindrical elastic plastic member 4. The cylindrical elastic plastic member 4 is directly molded from a polymeric material having a high tensile strength by means of injection molding, extrusion molding, or foam molding process. By means of controlling the plastic material used and the cylindrical body size, the cylindrical elastic plastic member 4 can control the desired working pressure within 10-1000 PSI. The characteristic of the cylindrical elastic plastic member 4 also allows for low-pressure output application. For low-pressure output applications, for example, supply of CO2 for watering grass at an output pressure about 15 PSI, polyurethane, ethylene vinyl acetate, or polyvinyl chloride of 60% DOP can be used to make the cylindrical elastic plastic member 4. For supplying oxygen in medical applications, the cylindrical elastic plastic member 4 can be molded from Teflon that is safe in use and meets FDA regulations. Further, because of high stability of high molecular structure and wide softness and hardness range, the cylindrical plastic member is applicable to all industrial pressure reducing valves.

The use of the cylindrical elastic plastic member in the pressure reducing valve has the following advantages:
1. Corrosion resistant, no rust problem.
2. Suitable for mass production through injection molding, extrusion molding, or foam molding to simplify fabrication.
3. Low manufacturing cost and ease of installation.
4. High material stability for accurate control of output pressure.
5. Wide hardness/softness range and wide range of working temperature for different applications.

Although particular embodiments of the invention have been described in detail for purposes of illustration, various modifications and enhancements may be made without departing from the spirit and scope of the invention. Accordingly, the invention is not to be limited except as by the appended claims.

The invention claimed is:

1. A pressure reducing valve comprising a housing connected to a high pressure gas source, an end cap fastened to one end of said housing, an enclosed accommodation chamber defined within said housing and said end cap, a piston mounted in said accommodation chamber, and an elastic member mounted in said accommodation chamber and stopped between said piston and a part of said housing, and an air chamber defined within said accommodation chamber between said end cap and said piston for receiving a compression gas guided into said housing to reduce the pressure of said compression gas for output, wherein said elastic member is molded from a polymer.

2. The pressure reducing valve as claimed in claim 1, further comprising a valve flap mounted in said end cap and movable to close/open said air chamber, and a return spring stopped at said valve flap to hold said valve flap in a close position closing said air chamber.

3. The pressure reducing valve as claimed in claim 1, wherein said elastic member is molded from plastics by means of injection molding, extrusion molding, or foam molding.
